(19) United States
(12) Patent Application Publication
(10) Pub. No.: US 2020/0390091 A1
(43) Pub. Date: Dec. 17, 2020

(54) COMPOSITIONS FOR INSECT REPELLANT

(71) Applicant: Mosquitoes Be Gone LLC, Ronkonkoma, NY (US)

(72) Inventor: Ruchi Shah, Ronkonkoma, NY (US)

(21) Appl. No.: 16/897,863

(22) Filed: Jun. 10, 2020

Related U.S. Application Data
(60) Provisional application No. 62/859,956, filed on Jun. 11, 2019.

(51) Int. Cl. A01N 25/02; A01N 65/26; A01N 65/36; A01N 65/40

(52) U.S. Cl. CPC A01N 25/02; A01N 65/40; A01N 65/36; A01N 65/26

(57) ABSTRACT

Non-toxic compositions for repelling mosquitoes are applied on the skin surface of an individual likely to be exposed to mosquitoes. The repellant includes one or more of neem oil, lime juice, coconut, olive oil, and water.

### CROSS REFERENCE TO RELATED APPLICATIONS

This claims the benefit of and priority to provisional U.S. Patent Application No. 62/859,956, filed on Jun. 11, 2019; the entire contents of which are incorporated herein by reference.

### BACKGROUND

### Technical Field

The present disclosure relates to methods and compositions for repelling mosquitoes and, more particularly, to a composition for an all-natural mosquito repellant.

It is well known that the common mosquito species Culex pipiens transmits communicable diseases, such as dengue and malaria, which greatly impact global human populations. The most common mosquito control methods include chemical insecticides and topical repellants for personal protection. The reliance on these insecticides and repellants has become a dilemma due to the development of resistance by mosquitoes and increased public concern about potential health and environmental hazards that result from exposure. There is a current need for innovative, safe and effective ways to control pest species of mosquitoes.

### SUMMARY

This disclosure relates to methods and compositions for repelling mosquitoes.

In accordance with aspects of the present disclosure, a non-toxic composition for repelling mosquitoes is presented. The composition includes between about 3% and 7% neem oil by volume of the total composition, and water forming the balance.

In an aspect of the present disclosure, the composition may further include between about 12% and 18% coconut oil by volume of the total composition.

In another aspect of the present disclosure, the composition may further include between about 12% and 18% coconut oil by volume of the total composition, and between about 4% and 8% olive oil by volume of the total composition.

In an aspect of the present disclosure, the composition may further include between about 13% and 18% lime juice by volume of the total composition.

In an aspect of the present disclosure, the composition may further include between about 12% and 18% coconut oil by volume of the total composition, and between about 13% and 18% lime juice by volume of the total composition.

In an aspect of the present disclosure, the composition may further include between about 12% and 18% coconut oil by volume of the total composition, between about 4% and 8% olive oil by volume of the total composition, and between about 13% and 18% lime juice by volume of the total composition.

In accordance with aspects of the present disclosure, a non-toxic composition for repelling mosquitoes is presented. The composition includes between about 13% and 18% lime juice by volume of the total composition, and water forming the balance.

In an aspect of the present disclosure, the composition may further include between about 12% and 18% coconut oil by volume of the total composition.

In an aspect of the present disclosure, the composition may further include between about 12% and 18% coconut oil by volume of the total composition, and between about 4% and 8% olive oil by volume of the total composition.

In accordance with aspects of the present disclosure, a non-toxic composition for repelling mosquitoes is presented. The composition includes between about 12% and 18% coconut oil by volume of the total composition, and water forming the balance.

In an aspect of the present disclosure, the composition may further include between about 4% and 8% olive oil by volume of the total composition.

In accordance with aspects of the present disclosure, a method for making a non-toxic composition for repelling mosquitoes is presented. The method includes adding lime juice to water. The method further includes adding olive oil to the lime juice and water. The method further includes adding neem oil to the olive oil, lime juice, and water. The method further includes adding coconut oil to the neem oil, olive oil, lime juice, and water. The method further includes mixing the coconut oil, neem oil, olive oil, lime juice, and water, for a predetermined period of time (e.g., one minute). The non-toxic repellant composition may include between about 3% and 7% neem oil by volume of the total composition, between about 10% and 35% coconut oil by volume of the total composition, between about 2% and 9% olive oil by volume of the total composition, between about 7% and 20% lime juice by volume of the total composition, and water forming a balance of the total composition.

In accordance with aspects of the present disclosure, a non-toxic composition for repelling mosquitoes includes: between about 3% and 7% neem oil by volume of the total composition, between about 10% and 35% coconut oil by volume of the total composition, between about 2% and 9% olive oil by volume of the total composition, between about 7% and 20% lime juice by volume of the total composition, and water forming a balance of the total composition.

Further details and aspects of various embodiments of the present disclosure are described in more detail below with reference to the appended figures.

### BRIEF DESCRIPTION OF THE DRAWINGS

A better understanding of the features and advantages of the disclosed technology will be obtained by reference to the following detailed description that sets forth illustrative embodiments, in which the principles of the technology are utilized, and the accompanying figures of which:

FIGS. 1A-E are diagrams of a custom-built tank apparatus for experimentation, in accordance with the present disclosure;

FIG. 2 is a graph illustrating mosquito attraction to male perspiration samples sprayed with mosquito repellants with different ingredient combinations, in accordance with the present disclosure;

FIG. 3 is a graph illustrating mosquito attraction to female perspiration samples sprayed with mosquito repellants with different ingredient combinations, in accordance with the present disclosure;

FIG. 4 is an illustration depicting a citric acid and ammonia neutralization reaction, in accordance with the present disclosure;

FIG. 5 is a graph illustrating preliminary mosquito attraction to the various female perspiration samples, in accordance with the present disclosure;

FIG. 6 is a graph comparing the number of mosquitoes that were attracted to the most attractive female perspiration sample out of each group, in accordance with the present disclosure;

FIG. 7 is a graph that illustrates the effect of the repellant on mosquito attraction, in accordance with the present disclosure;

FIG. 8 is a graph that illustrates the preliminary mosquito attraction to the various male perspiration samples, in accordance with the present disclosure;

FIG. 9 is a graph that compares the number of mosquitoes that were attracted to the most attractive male perspiration sample out of each group, in accordance with the present disclosure; and

FIG. 10 is a graph that illustrates the effect of the repellant on mosquito attraction, in accordance with the present disclosure.

Further details and aspects of exemplary embodiments of the disclosure are described in more detail below with reference to the appended figures. Any of the above aspects and embodiments of the disclosure may be combined without departing from the scope of the disclosure.

### DETAILED DESCRIPTION

This disclosure relates to non-toxic mosquito repellant compositions and methods for using them.

Although the present disclosure will be described in terms of specific embodiments, it will be readily apparent to those skilled in this art that various modifications, rearrangements, and substitutions may be made without departing from the spirit of the present disclosure.

For purposes of promoting an understanding of the principles of the present disclosure, reference will now be made to exemplary embodiments illustrated in the figures, and specific language will be used to describe the same. It will nevertheless be understood that no limitation of the scope of the present disclosure is thereby intended. Any alterations and further modifications of the present disclosure features illustrated herein, and any additional applications of the principles of the present disclosure as illustrated herein, which would occur to one skilled in the relevant art and having possession of this disclosure, are to be considered within the scope of the present disclosure.

Research being carried out to develop new repellants typically targets the molecular components of a mosquito's maxillary palp, which includes the neurons and sensory hairs. However, on the economic front, these new repellants can be quite expensive, rendering them unavailable to the poor, who are the majority of the people affected by mosquito-transmitted diseases. Additionally, the lack of human volunteers in testing new repellants makes the studies inaccurate. As an alternative, researchers have now begun using synthetic lures that imitate human scents. When used, artificial scents have been successful, but inconsistencies in results indicate that more research must be conducted in order to determine the effectiveness of various synthetic blends.

Aedes aegypti, a mosquito species which transmits yellow fever, is significantly more attracted to air infused with ammonia than air without it. It has now been found that significant number of Culex pipiens preferred the highest concentrations of ammonia and urea. Lime juice is a rich source of citric acid, as it contains about 1.38 g/oz. Citric acid is also a natural neutralizer of both ammonia and urea and was thus used in the repellants in accordance with the present disclosure. The present all-natural repellants created with lime, neem oil, and/or coconut oil are safer, more effective, and more cost-efficient than mosquito repellants currently on the market. The citric acid in the lime neutralizes the ammonia in an individual's perspiration, a combination of neem and coconut oils provide approximately 12-hour protection against mosquito bites, and olive oil help keeps the coconut oil liquid at room temperature while maintaining repellant consistency. Thus, the lime juice, neem oil, coconut oil, and olive oil combination works as a repellant since their combination creates a dual repellant effect as it both neutralizes and masks the attractive components.

The repellant serves the dual objective of eluding members of the insect family Culicidae, including mosquitoes, while eradicating chemical ramifications on the human body. The repellant contains a noxious odor to these insects that is innocuous to humans. While maintaining a pleasant fragrance, the product can be sprayed onto the skin both to drive away mosquitoes, not other humans. Furthermore, the repellant's innocuousness quells any human health doubts.

### Culex pipiens Repellency

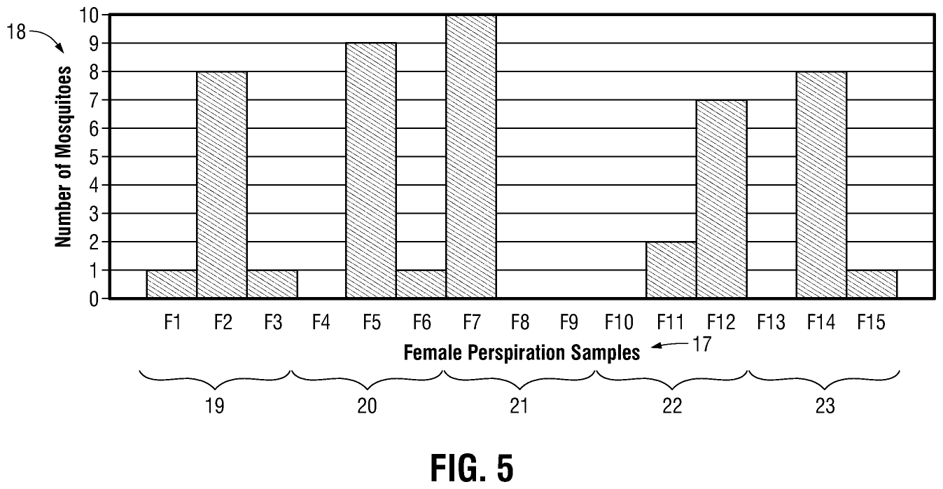

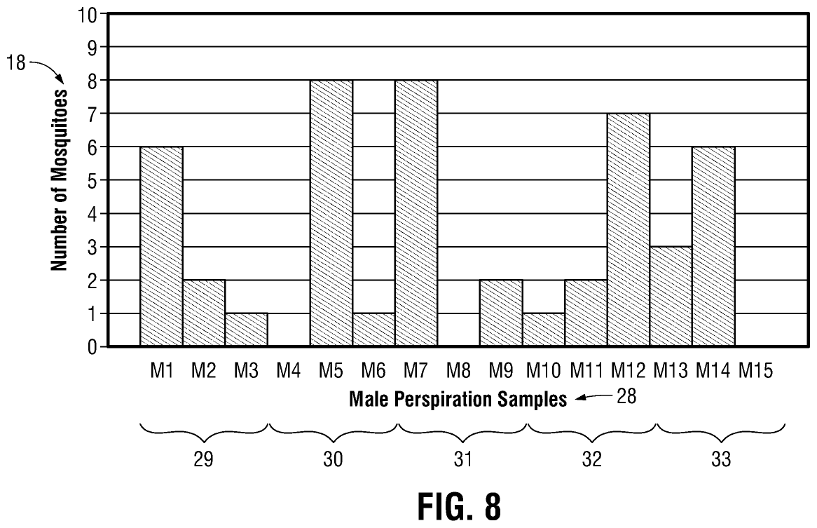

i. Sweat Collection—Sweat samples were collected in order to test the effectiveness of the present repellants. Thirty volunteers, fifteen males and fifteen females, were chosen at random. An equal number of male and female volunteers of varied race and social backgrounds were selected. However, the characteristics of the sweat donor did not have to be kept constant since the constituents of the sweat were not important to the study; the samples were only used to test the effectiveness of the proposed repellant. A simple random sample was then performed to randomly assign numbers to each donor. Thus, the volunteers were not labeled by name, but labeled by gender and number (F1-F15 and M1-M15) (see FIGS. 5 and 8). For example, female number four would be F4. Once the volunteers were selected and randomized, their foreheads were disinfected with rubbing alcohol and two gauze pads with a cotton ball in between were attached to each individual's forehead using latex-free tape. After attached, each volunteer conducted about 30 minutes of physical activity. At the end of the period, the samples were removed and placed in their own labeled airtight containers and stored in a freezer. To maintain full confidentiality, names were not placed on the samples when collected. Gloves were worn when handling each sample and gloves were changed before handling a new sample to prevent contamination.

ii. Proper Handling of Sweat Samples—The human sweat samples that were used in this study are characterized as Bio-Safety Level (BSL) one and were handled with caution to prevent any contamination. To prevent cross-contamination of the samples, they were handled with gloves, and gloves were changed between sample collections of different individuals. Once the samples were used in the study, they were sterilized in the autoclave before disposal.

iii. Culex pipiens—The mosquito species used for the experiment, Culex pipiens, were ordered as larvae from Carolina Biological Science Company. A glass tank (approximately 113,267 cu. cm), to house the C. pipiens larvae, was set up with two shallow pans of water (approximately 3.7843 liters). The larvae received about 8 hours of indirect artificial light and were fed mosquito diet every other day. As adults, the organisms were given sugar syrup (approximately 25% water, 75% sugar) to imitate the nectar they would feed on in their natural environment.

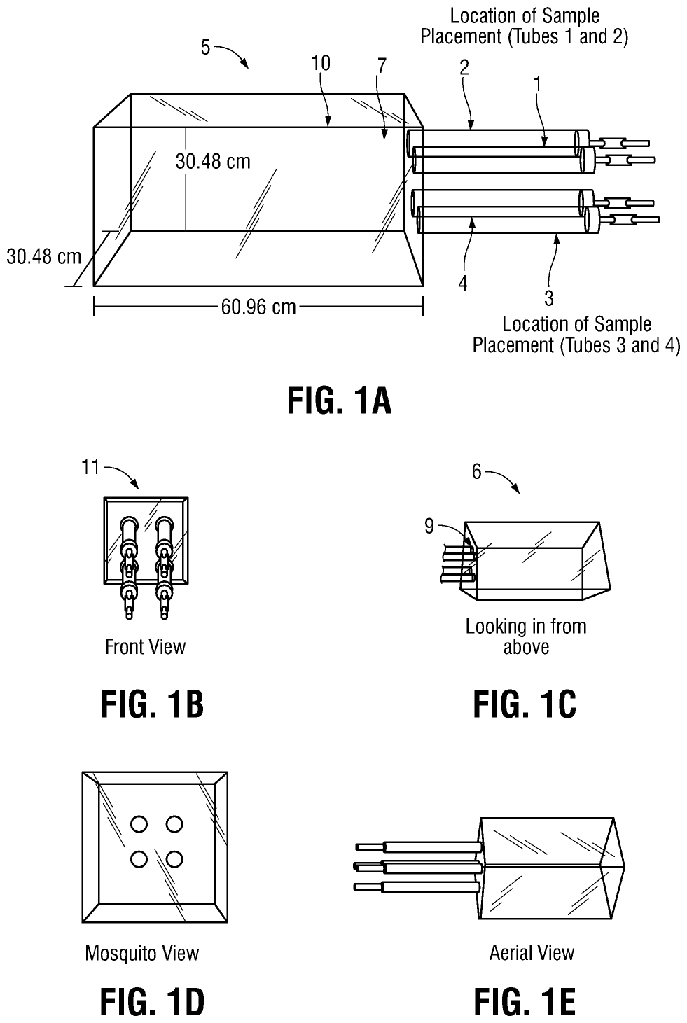

iv. Experimental Tank—An experimental tank (approximately 60.96 cm by 30.48 cm by 30.48 cm), to conduct the experiment, was constructed last year using sheets of Lexan. Four clear pipes, about 40.64 cm long, were attached to one side of the tank (FIG. 1). The samples were then placed in these pipes. The mosquitoes were placed into the tank through the opening at the top and the mosquitoes were allowed to choose their sample.

v. General Guidelines for Tank Usage—To reduce sources of error, several guidelines were followed when using the experimental tank. The samples were rotated after each set of two mosquitoes and the tubes were cleaned with an antiseptic. Visual obstructions were placed on all sides of the tank to prevent any visual stimuli from affecting the mosquitoes' choices. The air temperature of the tank was also kept within a certain range and all instruments were kept sterile.

With reference to FIGS. 1A-E, custom-built tank apparatus 5 includes four sides 8-11, a top 6, and a bottom 7. On side 11 of the custom-built tank apparatus 5, sample tubes 1-4 are disposed. FIG. 1 further shows the sample dimensions and different views of the custom-built tank apparatus 5.

vi. Preliminary Use—Once the samples were collected, they were split into groups of three. Each group had three different perspiration samples of the same gender along with water as a negative control. Each sample was placed inside of the experimental tank and different mosquitoes were put into the tank ten times. The mosquitoes were given about five minutes to choose their sample and were then removed. After the ten mosquitoes landed on the sample/s that they found most attractive, a conclusion was made about which of the four was most attractive. The data was recorded and used in the next tests.

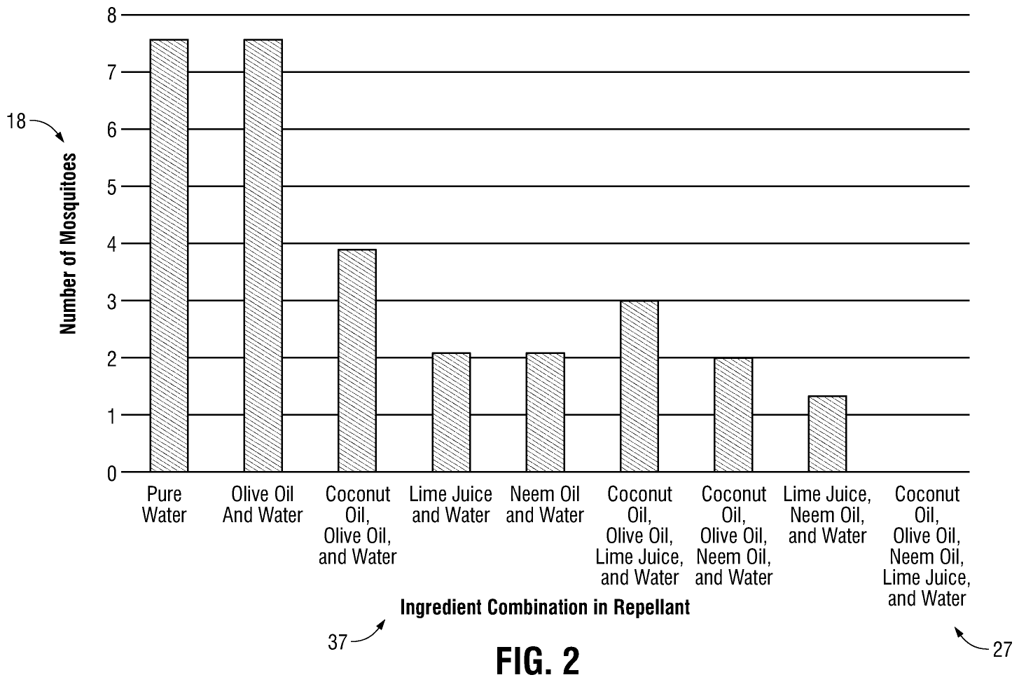

vii. Creation of Repellant—FIG. 2 is a graph that shows the attraction of mosquitoes 18 to male perspiration samples sprayed with mosquito repellants with ingredient combinations 37. The repellant ingredient combination 27 of coconut oil, olive oil, neem oil, lime juice, and water was most effective at repelling mosquitoes and was thus utilized throughout the remainder of experimentation.

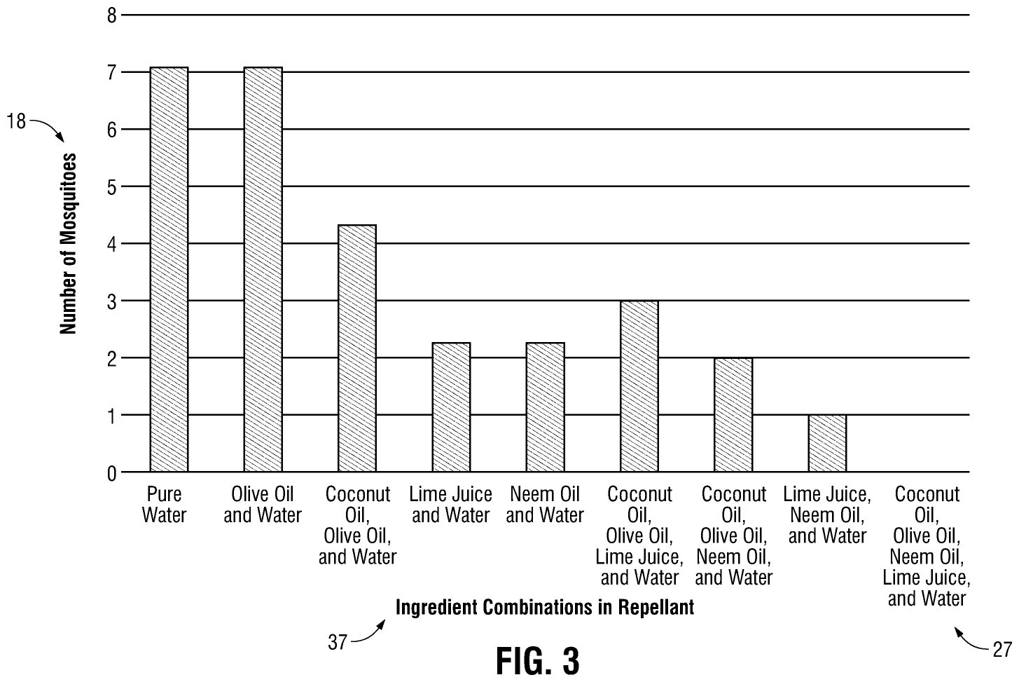

FIG. 3 is a graph that shows the attraction of mosquitoes 18 to female perspiration samples sprayed with mosquito repellants with ingredient combinations 37. Repellant ingredient combination 27 was most effective at repelling mosquitoes and was thus utilized throughout the remainder of experimentation.

This experimental repellant was created using neem oil, coconut oil, olive oil, lime juice, and/or water as the main ingredients. A proportionate ratio of lime to the average amount of ammonia in perspiration was used (e.g., the more perspiration in the same, the more lime was used in the mixture). Neem oil and coconut oil have a synergistic effect, and thus, approximately 1.1 to 1.5 times the amount of coconut oil was used. Since the olive oil helps keep the coconut oil liquid at room temperature while maintaining repellant consistency, conveying a synergistic effect, olive oil was added at about a 1:3 ratio to coconut oil by volume. Once the proper recipe was achieved, the solution was transferred to a spray bottle.

viii. Testing the Repellant—One spritz of the repellant, which is approximately 220 μL, was then sprayed onto the most attractive sample of each group of four, and all four samples were placed back into the experimental tank. Ten mosquitoes per group were introduced into the tank, two at a time, to determine the efficacy of the repellant. All data was recorded.

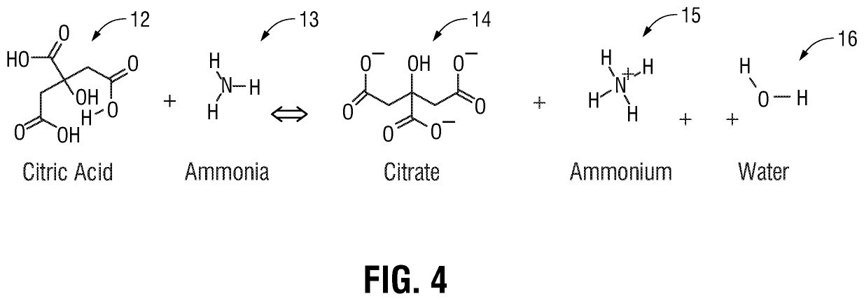

FIG. 4 is a graph that depicts a citric acid and ammonia neutralization reaction resulting from mixing citric acid 12 from the lime juice in the repellant with the ammonia 13 in the perspiration samples. The result is a combination of citrate 14, ammonium 15, and water 16. Mosquitoes are not nearly as attracted to ammonium as ammonia.

ix. Statistical Analysis—A Mann-Whitney rank sum test was used because of the ordinal and categorical nature of the data in order to calculate the p-value for males and females versus the repellant and the difference in activity of the mosquitoes between the genders.

### III. Results

In the control test, the C. pipiens were significantly attracted to the perspiration samples and noticeably preferred one sample of the group over the others (FIGS. 5, 6, 8, and 9). Once the most attractive sample in each group of the females was sprayed with the repellant, the mosquitoes were visibly repelled and would not approach that side of the tank (FIGS. 7 and 10). The data was so significant that a p-value of less than or equal to about 0.008 was determined through a Mann-Whitney Rank Sum Test. The repellants efficacy was similarly successful on the male samples yielding a p-value of less than or equal to about 0.008, suggesting that the repellant was effective for both genders against mosquitoes.

FIG. 5 is a graph that shows the preliminary attraction of mosquitoes 18 to various female perspiration samples 17. In each of Groups 19-23, there was one female sample that significantly attracted more mosquitoes than the others in the group.

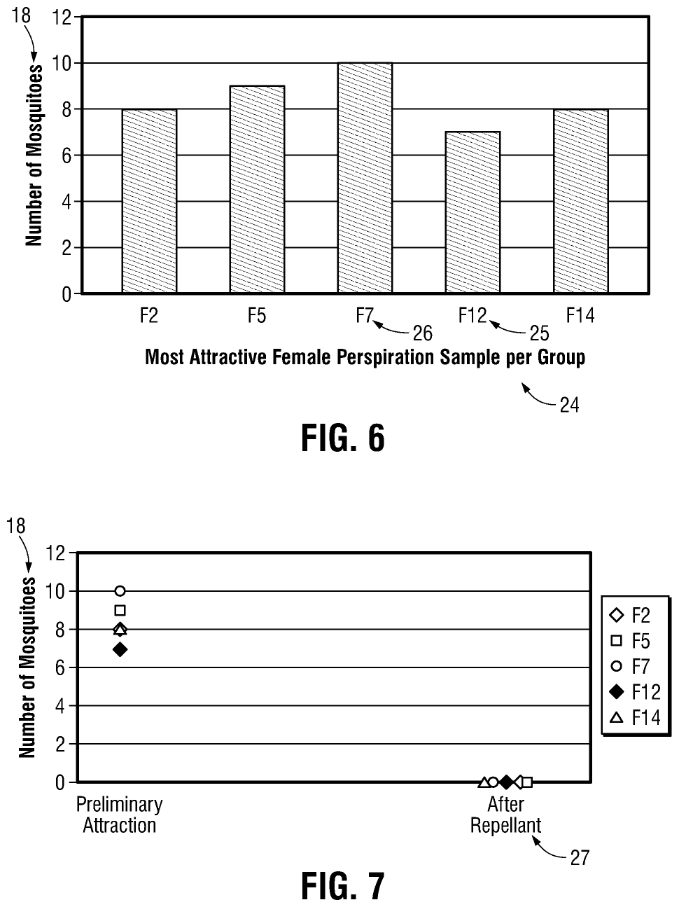

FIG. 6 is a graph that compares mosquitoes 18 that were attracted to the most attractive female perspiration sample out of each group (item 24). The mosquitoes were significantly attracted to one sample and there was little variance between the number of mosquitoes that were lured to the most attractive sample, since the number of mosquitoes ranged from seven in sample 25 to only ten in sample 26.

FIG. 7 is a graph that shows the effect of repellant 27 on mosquitoes 18 that are attracted to the sample. The once most attractive samples attracted no mosquitoes after the repellant was sprayed onto them. The substantial effect of the repellant as depicted by this graph is further represented by a p-value of about 0.008, which indicates a statistically significant reduction in the number of mosquitoes 18 caused by repellant 27.

FIG. 8 is a graph that shows the preliminary mosquito attraction of mosquitoes 18 to various male perspiration samples 28. In each of Groups 29-33, there was one male sample that significantly attracted more mosquitoes than the others in the group.

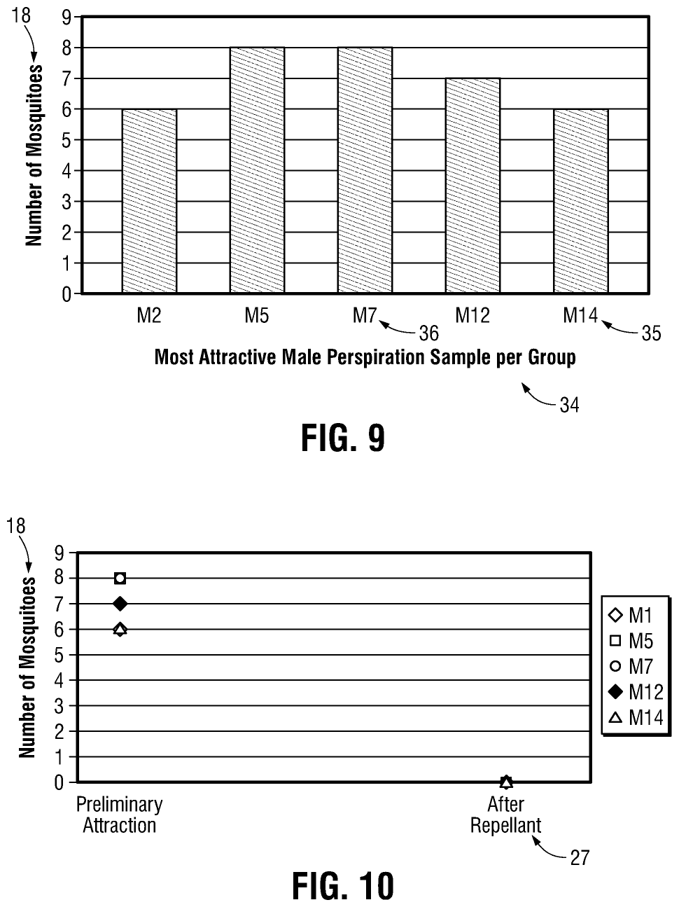

FIG. 9 is a graph that compares mosquitoes 18 that were attracted to the most attractive male perspiration sample out of each group (item 34). The mosquitoes were significantly attracted to one sample and there was little variance between the number of mosquitoes that were lured to the most attractive sample, since the number of mosquitoes ranged from six in sample 35 to only eight in sample 36. However, when compared to the female samples, the males had a slightly larger variance among the most attractive samples.

FIG. 10 is a graph that shows the effect of repellant 27 on mosquitoes 18 that are attracted to the sample. The once most attractive samples attracted no mosquitoes after the repellant was sprayed onto them. The substantial effect of the repellant as depicted by this graph is further represented by a p-value of about 0.008, which indicates a statistically significant reduction in the number of mosquitoes 18 caused by repellant 27.

A proportionate ratio of lime to the average amount of ammonia in perspiration was used (e.g., the more perspiration in the same, the more lime was used in the mixture). Neem oil and coconut oil have a synergistic effect, and thus, approximately 1.1 to 1.5 times the amount of coconut oil was used. Since the olive oil helps keep the coconut oil liquid at room temperature while maintaining repellant consistency, conveying a synergistic effect, olive oil was added at about a 1:3 ratio to coconut oil by volume. Thus, the repellant recipe used was about 5% neem oil, 15% lime juice, 15% coconut oil, 5% olive oil, and 60% water. Once the recipe was achieved, the solution was transferred to a spray bottle.

In various embodiments, the composition may include between about 2% and 15% neem oil by volume of the total composition, and water forming the balance. In embodiments, in addition to neem oil the composition may further include between about 10% and 35% coconut oil by volume of the total composition. In embodiments, in addition to neem oil the composition may further include between about 10% and 35% coconut oil by volume of the total composition, and between about 2% and 9% olive oil by volume of the total composition. In embodiments, in addition to neem oil the composition may further include between about 7% and 20% lime juice by volume of the total composition. In embodiments, in addition to neem oil the composition may further include between about 10% and 35% coconut oil by volume of the total composition, and between about 7% and 20% lime juice by volume of the total composition. In embodiments, in addition to neem oil the composition may further include between about 10% and 35% coconut oil by volume of the total composition, between about 2% and 9% olive oil by volume of the total composition, and between about 7% and 20% lime juice by volume of the total composition.

In various embodiments, a non-toxic composition for repelling mosquitoes is may include between about 7% and 20% lime juice by volume of the total composition, and water forming the balance. In embodiments, in addition to lime juice the composition may further include between about 10% and 35% coconut oil by volume of the total composition. In embodiments, in addition to lime juice the composition may further include between about 10% and 35% coconut oil by volume of the total composition and between about 2% and 9% olive oil by volume of the total composition.

In accordance with aspects of the present disclosure, a non-toxic composition for repelling mosquitoes is presented. The composition may include between about 10% and 35% coconut oil by volume of the total composition, and water forming the balance. In embodiments, in addition to coconut oil the composition may further include between about 2% and 9% olive oil by volume of the total composition.

In accordance with aspects of the present disclosure, a method for repelling mosquitoes includes forming a non-toxic repellant, applying the mosquito repellant on the skin surface of an individual, substantially covering the skin surface to be exposed to mosquitoes, and repeating applying on a daily basis whenever exposure to mosquitoes is likely. The repellant may include any of the compositions in accordance with embodiments of the present disclosure as described above. For example, the repellent may include between about 2% and 9% olive oil by volume of the total composition, between about 2% and 15% neem oil by volume of the total composition, between about 7% and 20% lime juice by volume of the total composition, between about 10% and 35% coconut oil by volume of the total composition, and water forming the balance.

In accordance with aspects of the present disclosure, a method for making a non-toxic composition for repelling mosquitoes, includes initially, adding lime juice to water. Next, the method includes adding olive oil to the lime juice and water. Next, the method includes adding neem oil to the olive oil, lime juice, and water. Next, the method includes adding coconut oil to the neem oil, olive oil, lime juice, and water. Next, the method includes mixing the coconut oil, neem oil, olive oil, lime juice, and water for a predetermined period of time (e.g., one minute). The non-toxic repellant composition may include between about 3% and 7% neem oil by volume of the total composition, between about 10% and 35% coconut oil by volume of the total composition, between about 2% and 9% olive oil by volume of the total composition, between about 7% and 20% lime juice by volume of the total composition, and water forming a balance of the total composition.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure.

The phrases “in an embodiment,” “in embodiments,” “in various embodiments,” “in some embodiments,” or “in other embodiments” may each refer to one or more of the same or different embodiments in accordance with the present disclosure.

It should be understood that the description herein is only illustrative of the present disclosure. Various alternatives and modifications can be devised by those skilled in the art without departing from the disclosure. Accordingly, the present disclosure is intended to embrace all such alternatives, modifications, and variances. The embodiments described are presented only to demonstrate certain examples of the disclosure. Other elements, steps, methods, and techniques that are insubstantially different from those described above and/or in the appended claims are also intended to be within the scope of the disclosure.

What is claimed is:

1. A non-toxic composition for repelling mosquitoes, the composition comprising:
between about 3% and 7% neem oil by volume of the total composition, and
water forming a balance of the total composition.

2. The composition of claim 1, the composition further including:
between about 12% and 18% coconut oil by volume of the total composition.

3. The composition of claim 1, the composition further including:
between about 12% and 18% coconut oil by volume of the total composition, and
between about 4% and 8% olive oil by volume of the total composition.

4. The composition of claim 1, the composition further including:
between about 13% and 18% lime juice by volume of the total composition.

5. The composition of claim 1, the composition further including:
between about 12% and 18% coconut oil by volume of the total composition, and
between about 13% and 18% lime juice by volume of the total composition.

6. The composition of claim 1, the composition further including:
between about 12% and 18% coconut oil by volume of the total composition,
between about 4% and 8% olive oil by volume of the total composition, and
between about 13% and 18% lime juice by volume of the total composition.

7. A non-toxic composition for repelling mosquitoes, the composition comprising:
between about 13% and 18% lime juice by volume of the total composition, and
water forming a balance of the total composition.

8. The composition of claim 7, the composition further including:
between about 12% and 18% coconut oil by volume of the total composition.

9. The composition of claim 7, the composition further including:
between about 12% and 18% coconut oil by volume of the total composition, and
between about 4% and 8% olive oil by volume of the total composition.

10. A non-toxic composition for repelling mosquitoes, the composition comprising:
between about 12% and 18% coconut oil by volume of the total composition, and
water forming a balance of the total composition.

11. The composition of claim 10, the composition further including:
between about 4% and 8% olive oil by volume of the total composition.

12. A method for making a non-toxic composition for repelling mosquitoes, comprising:
adding lime juice to water;
adding olive oil to the lime juice and water;
adding neem oil to the olive oil, lime juice, and water;
adding coconut oil to the neem oil, olive oil, lime juice, and water;
mixing the coconut oil, neem oil, olive oil, lime juice, and water, for a predetermined period of time,
wherein the non-toxic repellant composition includes:
between about 3% and 7% neem oil by volume of the total composition;
between about 10% and 35% coconut oil by volume of the total composition;
between about 2% and 9% olive oil by volume of the total composition;
between about 7% and 20% lime juice by volume of the total composition; and
water forming a balance of the total composition.
